(19) United States
(12) Patent Application Publication
(10) Pub. No.: US 2012/0075444 A1
(43) Pub. Date: Mar. 29, 2012

(54) VIDEOENDOSCOPE WITH CONFIGURABLE TACTILE CONTROLS

(75) Inventor: Jean Rovegno, La Ciotat (FR)

(73) Assignee: TOKENDO, La Ciotat (FR)

(21) Appl. No.: 12/893,829

(22) Filed: Sep. 29, 2010

(51) Int. Cl. H04N 7/18

(52) U.S. Cl. 348/65; 348/E07.085

(57) ABSTRACT

The invention relates to a videoendoscope comprising a videoendoscopic probe comprising an inspection tube having a distal end housing an image sensor, and a control handle fixed to the proximal end of the inspection tube, the control handle comprising a display screen, and a video processing circuit connected to the image sensor and the display screen, the display screen being covered by a touch panel, and having a format such that its surface may be divided into an image display area occupying a whole height of the display screen and having a format corresponding to that of a photosensitive surface of the image sensor, and a lateral control key display area having a sufficient surface to display several control keys of sufficient size to be individually operated.

The present invention relates to a videoendoscopic probe of the compact type comprising a control handle housing a tip deflection control device, an acquisition, process and image storing device, as well as a flat screen allowing endoscopic images to be visualized. The present invention applies particularly, but not exclusively, to industrial endoscopy.

The term “videoendoscope” generally refers to an endoscopy system allowing the image of a target located in a dark cavity to be observed on a video screen. Such a system more usually comprises a videoendoscopic probe, and additional operating devices. A videoendoscopic probe usually comprises a distal tip, a usually flexible inspection tube, which distal end is attached to the distal tip, a control handle attached to the proximal end of the inspection tube, a lighting device for lighting the target observed, an image processing device, a visualization screen, a control key panel and a flexible umbilical cable which distal end is attached to the control handle.

The distal tip houses an objective and an optoelectronic device of small dimensions comprising in particular an image sensor associated to an interface circuit. The objective is associated to the image sensor so as to form an image on the photosensitive surface of the image sensor. The image sensor may for example be of the type interline transfer three CCD or CMOS sensor. The proximal end of the umbilical cable is provided with a multiple connector allowing the probe to be connected to an additional operating device. The lighting device generally comprises a beam of lighting fibers successively housed in the umbilical tube, the control handle, and the inspection tube. The distal end of the beam of lighting fibers is integrated into the distal tip, to light the target. The proximal end of the beam of lighting fibers is housed into the multiple connector of the umbilical cable to be connected to a light generator. The image processing device comprises a video processor which may be housed in the control handle. The video processor is then linked to the distal image sensor by a multicore electric cable housed in the inspection tube. The video processor simultaneously acts on the synchronization of the image sensor and the amplitude of the unprocessed analog signal supplied by the latter. The video processor is configured to transform into a useful video signal the analog signal supplied by the distal image sensor. To that end, the video processor is synchronized by an original setting according to the length and electrical features of the multicore cable housed in the inspection tube. The visualization screen allows the useful video signal supplied by the image processing device to be viewed. It may be flat and embedded on the control handle. The control key panel allows the operation parameters of the image processing device to be set, and may also be embedded on the control handle.

Generally, videoendoscopic probes may also comprise a distal jointed tip deflection, and interchangeable optical heads which may be locked on the distal tip of the probe. The tip deflection allows the direction of the distal tip of the inspection tube to be modified. It is operated by mechanical means (controlled by two thumb wheels and two locking levers) or electromechanical means (controlled by a joystick) which may be integrated into the control handle. The interchangeable optical heads allow all or part of the following optical parameters to be modified: the field covered by the optical objective associated to the image sensor, the focusing distance, the depth of field, and the viewing direction. Distal heads also exist, configured to generate a splitted image susceptible of being processed by a specific three-dimensional measurement program.

The additional operating devices susceptible of being connected to the proximal end of the umbilical cable may comprise an electric power supply which comprises a storage battery, or a case which can be connected to a source of alternating or direct current. They may also comprise a light generator conventionally comprising a halogen or xenon lamp. They may also comprise a digital processing and image saving device comprising either a simple portable computer equipped with a video input, or a dedicated system which may be controlled locally from the control panel on the handle of the videoendoscopic probe. The digital processing device may be configured to save unitary images or sequences of images on a removable digital support susceptible of being read by the image processing device or a computer. The digital processing device may also implement a three-dimensional measurement program allowing a “stereo” distal head to be used.

Recently, the miniaturization of components has allowed a lighting device to be implemented, which does not comprise a remote lighting lamp conventionally used in endoscopy, but one or more electroluminescent diodes. It has also become possible to integrate into the video processor one or more dedicated digital devices to manage in real time functions such as image freezing, progressive zoom, image inversion in particular to compensate the optical original image inversion introduced by the partial reflection prisms integrated into the deviated viewing distal heads. To improve the global sensitivity of a videoendoscopic probe, a low speed electronic shutter control has also been integrated into the video processor, lower than the duration of a video frame (i.e. 1/50 s in PAL standard or 1/60 s in NTSC standard).

The currently most universal and efficient videoendoscopes gather the devices previously mentioned. To that end, two types of very different architectures may be implemented. In a first type of architecture, the videoendoscopic probe is associated to a remote operating device connected to the end of the umbilical cable. The control handle of the videoendoscopic probe may then gather a tip deflection powering device, a lighting device by LED to light the target observed, a video processor provided with image processing functions in real time, such as progressive zoom and low speed shutter control, and a control panel comprising a joystick for controlling the tip deflection and several keys allowing the functions of the video processor to be directly controlled and the functions integrated into the remote operating device to be remotely controlled. The operating device may then comprise a function for saving and processing in delay time endoscopic images, a visualization screen, a control key panel, an electric power supply by battery or alternating current, and possibly, a connection base of an auxiliary visualization screen. The visualization screen of the operating device has a 4/3 format corresponding to that of the photosensitive surface of the image sensor, and dimensions sufficient to perform with enough precision pointing inherent to the implementation of a three-dimensional measurement program. The control key panel of the operating device allows the functions for saving and processing images in delay time to be controlled, and the functions integrated into the handle of the videoendoscopic probe to be remotely controlled.

In the second type of architecture, the control handle performs all the functions of the control handle of the videoendoscopic probe of the first type of architecture and of the remote operating device.

In both types of architectures, the simultaneous management by a same keypad of keys of image saving or processing functions in real time and image processing functions in delay time has the ergonomic drawback of allocating to each control key several functions, each corresponding to an operating phase.

It is therefore desirable to make a videoendoscopic probe which is both compact and ergonomic.

Embodiments relate to a method for controlling a videoendoscope comprising a videoendoscopic probe comprising an inspection tube having a distal end housing an image sensor, and a control handle fixed to the proximal end of the inspection tube, the control handle comprising a display screen, and a video processing circuit connected to the image sensor, and the display screen. According to one embodiment, the method comprises: providing the control handle with a display screen and a touch panel covering the display screen, the display screen and the touch panel having a format such that their surface may be divided into an image display area occupying a whole height of the display screen and having a format corresponding to that of a photosensitive surface of the image sensor, and a lateral control key display area having a sufficient surface to display several control keys of sufficient size to be individually operated, and controlling the display screen and the touch panel so as to display an image elaborated from signals coming from the image sensor in the image display area, and several control keys in the lateral control key display area.

According to one embodiment, the method comprises controlling the display screen and the touch panel so as to display and manage in the control key display area all the control keys necessary to a usual operating phase of the videoendoscopic probe.

According to one embodiment, the method comprises controlling the display screen and the touch panel so as to have the control key display area at the left and/or at the right of the image display area, according to a configuration parameter.

According to one embodiment, the method comprises controlling the display screen so as to have a control key in the control display area in various ways according to the state of a function controlled by the control key.

According to one embodiment, the method comprises controlling the display screen and the touch panel so as to display and manage navigation keys upward, downward, leftward and rightward, to control a distal tip deflection of the videoendoscopic probe.

According to one embodiment, the method comprises configuring the videoendoscopic probe in an autonomous control mode in which the probe is controlled from the touch panel, or in a remote mode in which the probe is controlled from a computer to which it is connected.

According to one embodiment, the method comprises controlling the videoendoscopic probe so as to perform at least one of the following is functions: managing information configured according to an operating phase currently processed and displayed in the image display area, managing control keys displayed in the control key display area, according to the operating phase currently processed, and managing orders introduced through the touch panel, by activating a control key displayed.

Embodiments also relate to a videoendoscope comprising a videoendoscopic probe comprising an inspection tube having a distal end housing an image sensor, and a control handle fixed to the proximal end of the inspection tube, the control handle comprising a display screen, and a video processing circuit connected to the image sensor, the display screen and a proximal multicore cable allowing the video processing circuit to be connected to an operating equipment. According to one embodiment, the display screen is covered by a touch panel, the display screen and the touch panel having a format such that their surface may be divided into an image display area occupying a whole height of the display screen and having a format corresponding to that of a photosensitive surface of the image sensor, and a lateral control key display area having a sufficient surface to display several control keys of sufficient size to be individually operated, the videoendoscope being configured to implement the method previously defined.

According to one embodiment, the display screen and the touch panel have a 16/9 format, while the photosensitive surface of the image sensor has a 4/3 format.

According to one embodiment, the video processing circuit is connected to a proximal multicore cable allowing the video processing circuit to be connected to an external operating equipment.

Embodiments also related to a videoendoscopic system comprising a videoendoscope and a computer connected to the videoendoscope through an interface circuit. According to one embodiment, the videoendoscope is such as previously defined.

According to one embodiment, the computer is configured to perform, in a remote control mode of the videoendoscope, at least one of the following functions: parametering and process functions in real time of the video signals processed by the video processor VP, saving and processing in delay time the video signals, executing an image process program in delay time, and visualizing images coming from the videoendoscopic probe and coming from process in delay time.

According to one embodiment, the interface circuit is configured to be connected to the computer through a link of USB type to transmit video images between the videoendoscope and the computer, and a link of USB type to transmit commands of the videoendoscope from the computer in a remote control mode of the videoendoscope.

Embodiments of the invention will be described hereinafter, in relation with, but not limited to the appended figures wherein:

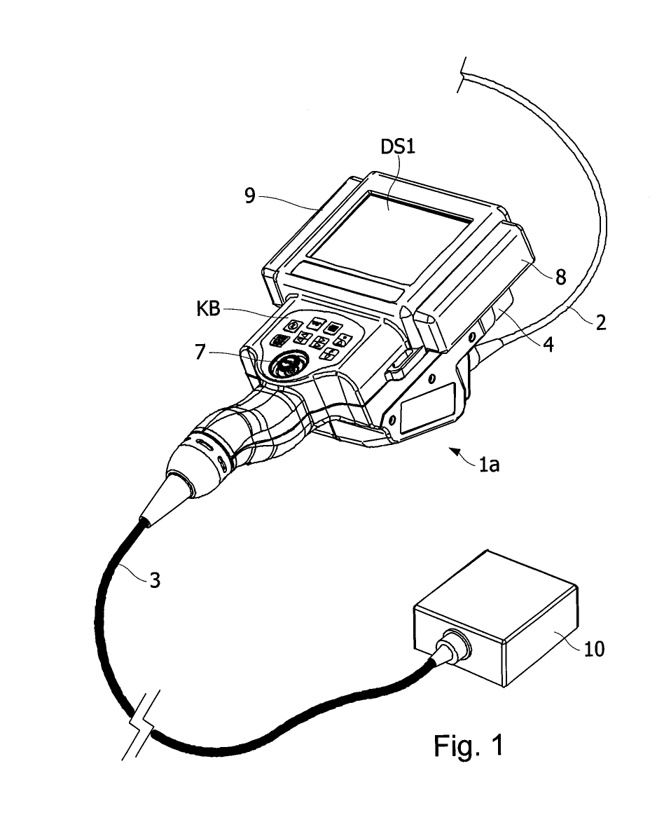

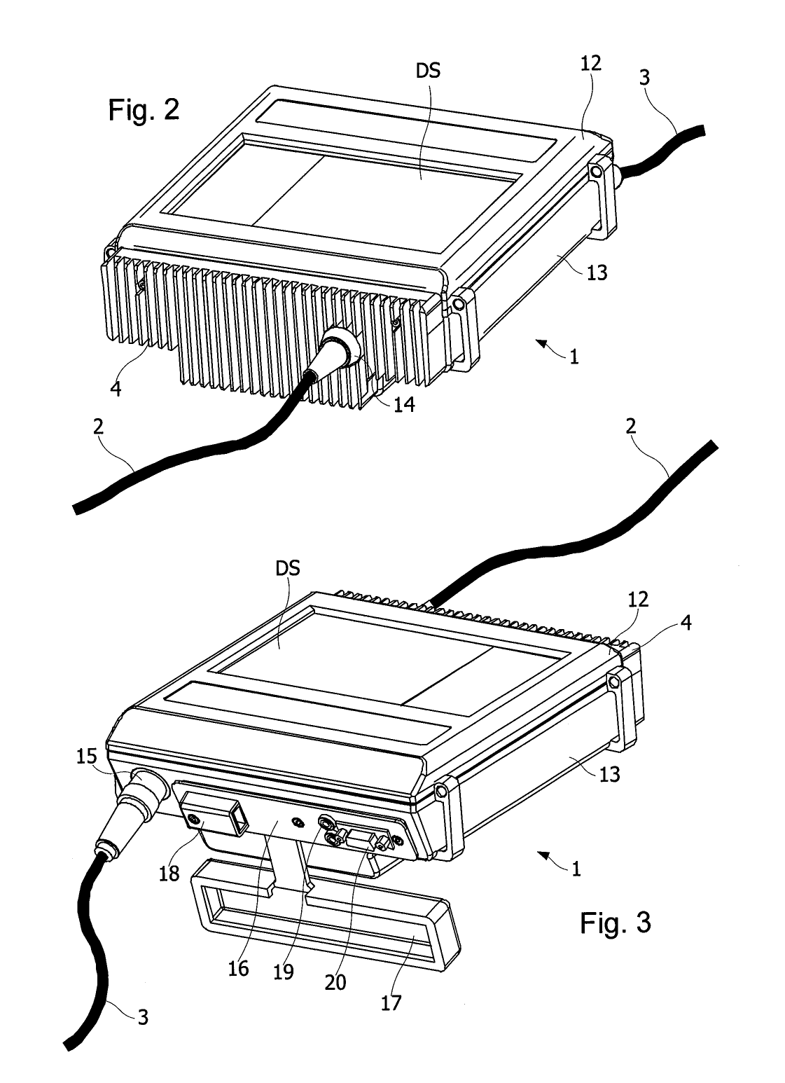

FIG. 1 is a perspective view of a conventional compact videoendoscopic probe,

FIGS. 2 and 3 are perspective views of the distal and proximal faces of a compact videoendoscopic probe, according to one embodiment,

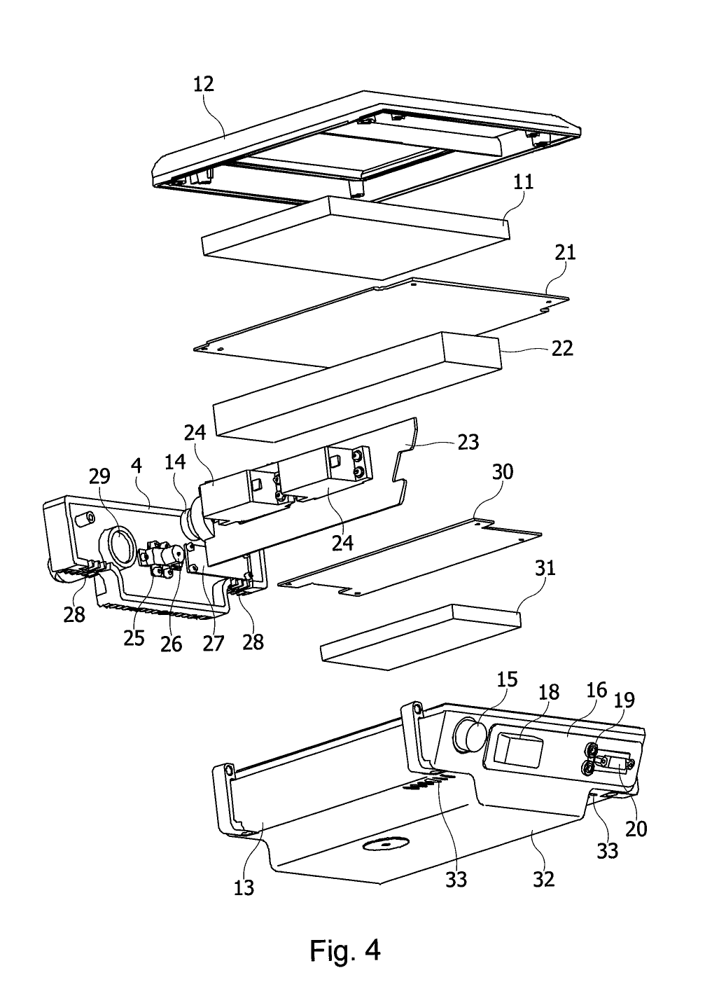

FIG. 4 is an exploded view in perspective of the videoendoscopic probe of FIG. 2,

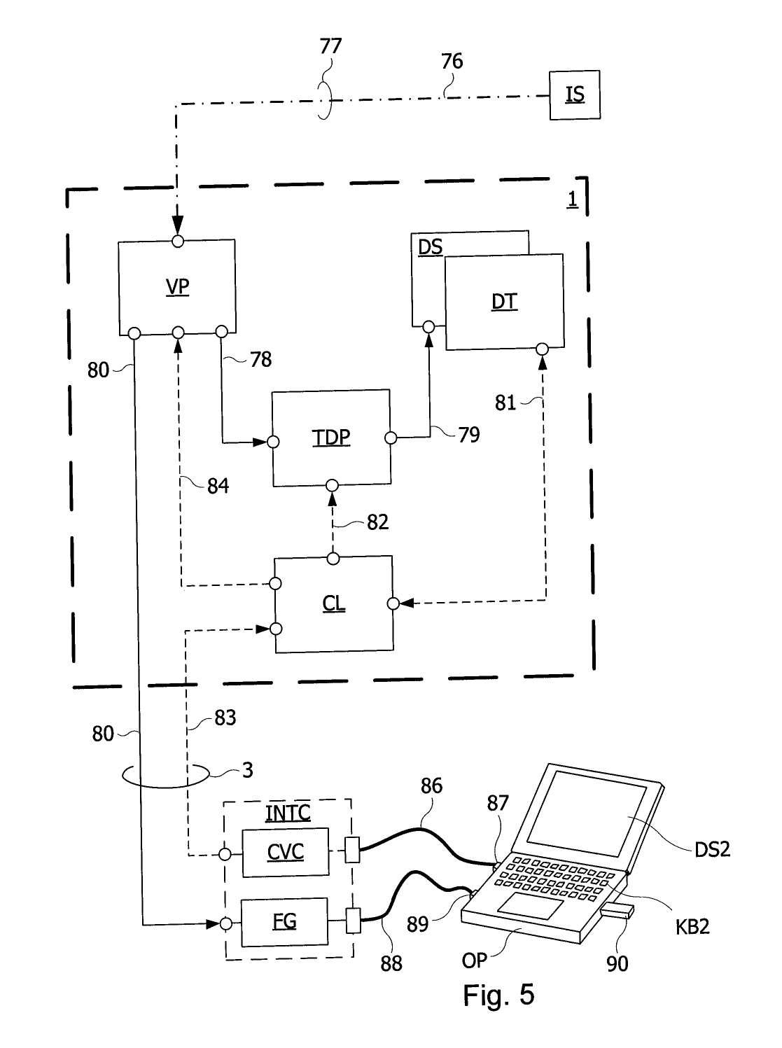

FIG. 5 schematically shows electronic circuits of the videoendoscopic probe, according to one embodiment,

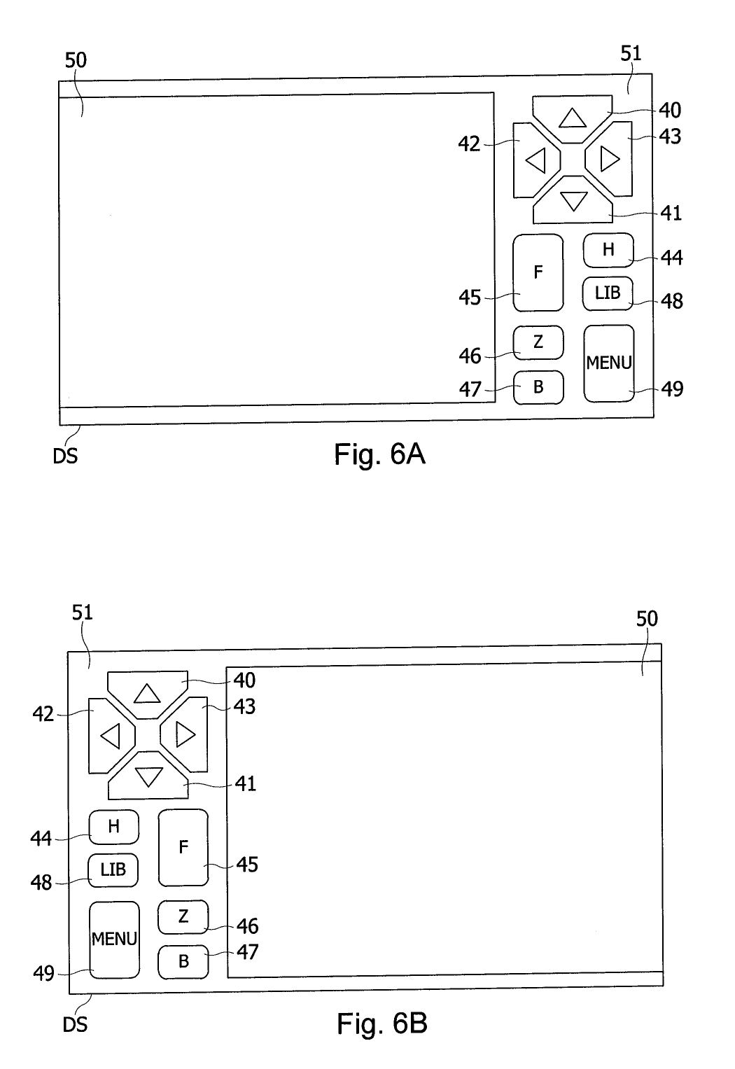

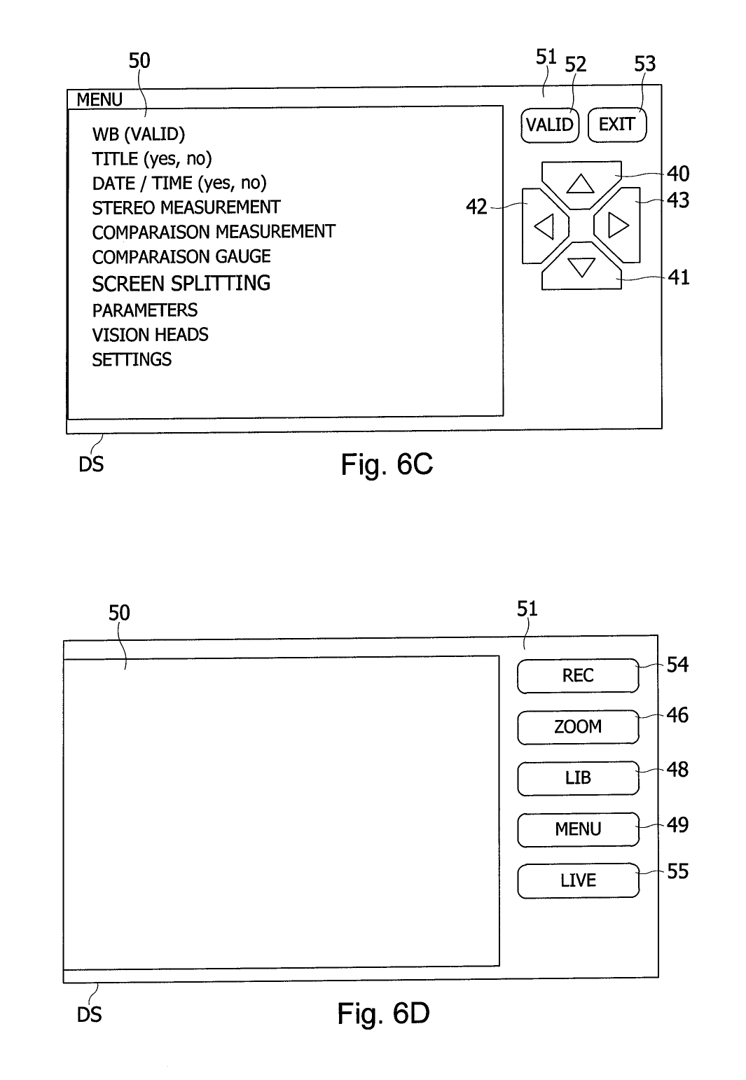

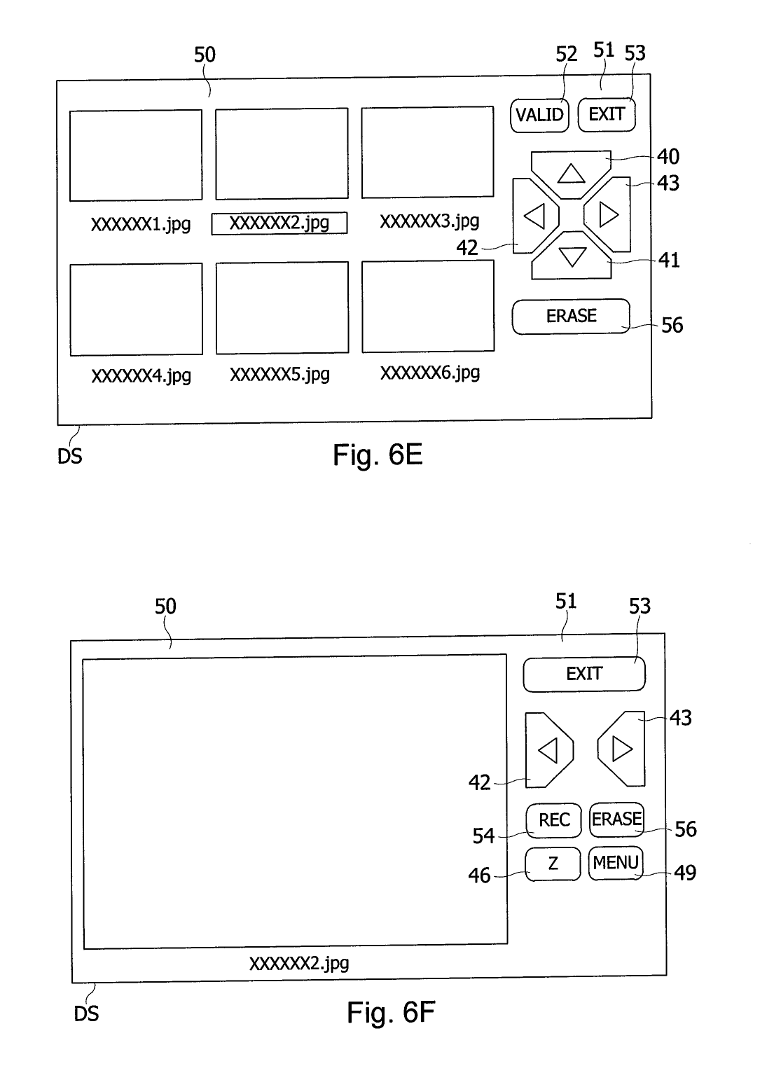

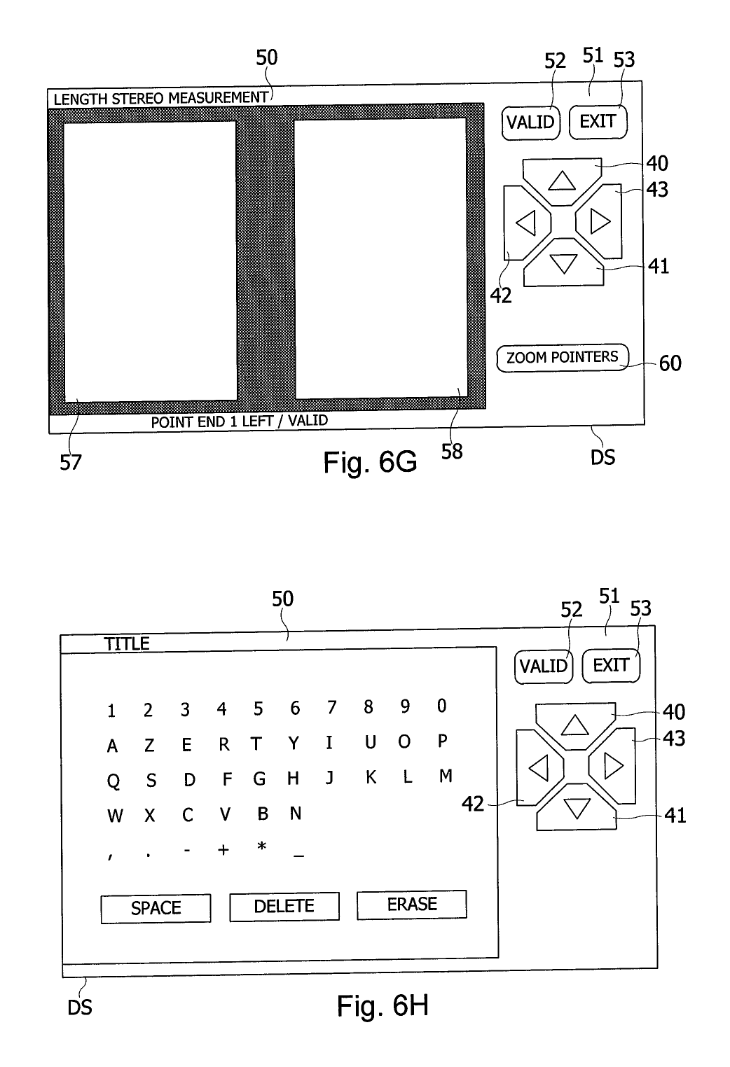

FIGS. 6A to 6H show various image configurations displayed on the screen of the videoendoscopic probe of FIGS. 2 to 4.

FIG. 1 shows a conventional compact videoendoscopic probe comprising a control handle 1a attached to the proximal end of a flexible inspection tube 2 and the distal end of an umbilical cable 3. The cable 3 has a proximal end connectable to a power supply device 10. The handle 1a houses a tip defection powered control device, a lighting device using diode LED, a video processor with processing functions in real time, and a digital image saving or processing device in delay time. The handle 1a also supports a radiator 4 housing the lighting diode LED, and a visualization screen DS1 for displaying images in the conventional 4/3 format corresponding to the proportions of the photosensitive surface of the image sensors used in videoendoscopy. The handle 1a also supports two flexible covers 8, 9 guaranteeing the tightness of two connection plates allowing a USB key for saving images, a headset, and an auxiliary video output to be connected. The handle 1a also supports a control panel KB comprising a is joystick 7 for tip deflection control, and a set of control keys, for example tactile. The control keys make it possible to control in particular, in a “live” operating mode of the probe, image saving functions, real time functions of the video processor, . . . , and in a “menu” operating mode, functions for reading prestored images, video parametering, delay time process, . . . .

According to one embodiment, the videoendoscopic probe comprises a compact and ambidextrous control handle housing a powered tip defection control device, a lighting device using diode LED to light the target observed, a video processor, and a visualization and control device. The video processor performs real time process functions such as: image inversion, image freezing, progressive zoom, low speed electronic shutter, . . . . The visualization and control device comprises a flat visualization screen in the 16/9 format, associated to a touch panel of same dimensions as the screen and arranged thereon. The visualization screen is divided into two display areas, i.e. a first display area at the 12/9 format (i.e. 4/3), dedicated to the display of endoscopic images, and a second display area in the 4/9 format, dedicated to the display of touch control keys. The first display area therefore has a format corresponding to the proportions of CMOS or CCD image sensors susceptible of being integrated into the distal end of the videoendoscopic probe. The second display area may be displayed at the right or the left of the first display area, according to the choice of the user, for example according to whether s/he is right or left handed. The touch control keys shown in the second display area are automatically reconfigured and renamed at each operating phase, so as to show to the user only the keys which are strictly necessary to the management of the current operating phase.

The control handle also houses a digital device for saving and processing images, programmed to perform the following functions:
managing information configured according to the operating phase currently processed and displayed in the first screen display area, i.e.: endoscopic images, comment texts, operating instructions, alphanumeric keyboard, . . . .
managing control keys displayed according to the operating phase currently processed, and displayed in the second display area, and
managing orders introduced through the touch panel and resulting from the activation of the control keys displayed on the visualization screen.

The orders input through the control keys relate in particular to the following functions:
controlling the tip deflection powering device of the videoendoscopic probe,
parametering the video processor,
controlling the image processing functions in real time of the video processor,
controlling the functions for saving unitary images or sequences of images, and
controlling various image processing functions in delay time, such as reading stored images, procedures of measurement by comparison, procedures of three-dimensional measurement, . . . .

The digital image saving and processing device may comprise a dedicated digital signal processor designed to that end, or, an embedded card of PC type, associated to a compression video to USB converter. The implementation of a PC card has the advantage of offering standard interfaces for the connection of an auxiliary visualization screen, for example in the LVDS or VGA standard, and a USB key for storing images.

Due to the fact that it is integrated into the control handle, the digital image processing device has a necessarily small physical size, and is therefore limited in terms of memory capacity and processor resource. The digital device may therefore not comply with inspection methods implying heavy procedures such as modeling programs or programs for consulting digital maintenance manuals, accessible only using a computer having a significant computing power. Thus, the videoendoscopic probe may, according to one embodiment, comprise a specific umbilical cable susceptible of being connected to an external computer through an interface device configured to allow the user to remotely control the probe from the computer keyboard, and thus to implement specific image processing programs.

FIGS. 2 and 3 show a videoendoscopic probe, according to one embodiment. The probe comprises a control handle 1 attached to the proximal end of a flexible inspection tube 2 which distal end houses an optoelectronic device comprising an image sensor, and to the distal end of is an umbilical cable 3 which proximal end can be connected to a power supply device. The handle 1 comprises a case comprising a higher shell 12 and a lower shell 13, and housing:
a distal tip deflection powered control device,
a lighting device using diode LED to light a target observed through the distal tip of the probe,
a video processor performing real time video processing functions such as zoom, image freezing and low speed shut,
a digital processing device performing functions of saving/reading images and processing images in delay time.

The handle 1 also supports a distal radiator 4 housing the lighting diode LED, and supporting a base 14 attached to the proximal end of the inspection tube 2. The handle 1 also comprises a proximal connection device comprising an electric connection base 15 for connecting the umbilical cable 3, and a connection plate 16 protected by a sealing cover 17, for example flexible. The plate 16 gathers a connector 18 of a memory card, such as a USB key, bases 19 for connecting a headset, and a video output base 20 which can be connected to an auxiliary visualization screen, for example of VGA type.

The handle 1 also supports a visualization screen DS in the 16/9 format associated to a transparent touch panel of same format. The visualization screen DS comprises an image display area in the 12/9 format (i.e. 4/3) and a control area in the 4/9 format.

FIG. 4 shows the mechanical arrangement of the elements of the control handle 1, according to one embodiment. The higher shell 12 is made in molded plastic and internally metalized. The handle 1 comprises a metallic shield plate 21 intended to be fixed to the higher shell 12. The plate 21 supports the visualization screen DS on its higher face and its lower face, an electronic card 22 in which the digital image processing device is embedded.

The processing device may comprise a compression video to USB converter and an embedded processing card of PC type. The processing device is connected to the screen DS which may be in the LVDS standard, the control touch panel, the auxiliary video output 20, and the connector 18 to connect to a USB key allowing unitary images, for example in the JPEG standard and sequences of images, for example in the MPEG4 standard, to is be stored and read.

The handle 1 comprises a metallic plate 23 supporting two servomotors 24, each driving a pulley coupled to a pair of cables controlling the angulation in a (vertical or horizontal) plane of the tip deflection integrated into the distal end of the inspection tube 2. The plate 23 also supports the base 14 at the proximal end of the inspection tube 2.

The handle 1 comprises a metallic shield plate 30 which is fixed to the higher shell 13. The plate 30 supports the video processor 31 which positions into a housing 32 provided to that end in a lower part of the shell 13. The processor 31 is linked to the image sensor housed in the distal end of the inspection tube 2 through a multicore cable housed in the tube. The processor supplies a video signal which is transmitted to the digital image processing device on the card 22.

The lower shell 13 may be made in molded plastic and internally metalized, and fixes to the higher shell 12. The shell 13 comprises ventilation orifices 33 and supports the electric base 15 for connecting the umbilical cable 3. The radiator 4 is fixed to the distal face of the shell 13 and has an internal recess in which are arranged a circuit 25 supporting the lighting diode LED, a U-bolt 26 maintaining the proximal end of a beam of lighting fibers housed in the inspection tube 2 and which distal end is housed at the distal end of the tube 2 to be able to light the target to be inspected, and a power supply circuit 27 of the diode LED. The radiator 4 comprises ventilation inlets 28 and a circular orifice 29 housing the base 14 at the proximal end of the inspection tube 2.

The connection plate 16 is fixed to the proximal face of the lower shell 13 and supports the connection interfaces 18, 19, 20 of a USB key, a headset, and an auxiliary visualization screen.

FIG. 5 shows electronic circuits of the videoendoscopic probe, according to one embodiment. The endoscopic probe may operate as well in an “autonomous” control mode as in a “remote control” mode, in which it is controlled by an external computer susceptible of implementing image processing programs in delay time which may be much more powerful than those managed by the processing device integrated into the control handle 1.

The electronic circuits housed in the handle 1 comprise the video processor VP, the video processing device TDP, a control circuit CL, the display screen DS, and the transparent control touch panel DT. The video processor VP performs image processing functions in real time (zoom, freezing, image inversion, low speed electronic shutter . . . ) and setting functions for some video parameters (colorimetry, vertical and horizontal outlines . . . ). The processing device TDP performs functions of image viewing, image storing and processing in real time. The processing device TDP comprises for example an embedded PC card associated to a compression video to USB converter. The control circuit CL performs managing all the electronic functions integrated into the control handle 1.

In “autonomous” control mode, the image sensor IS integrated into the distal tip of the probe transmits an electrical signal 76 to the video processor VP through a multicore cable 77 housed in the inspection tube 2. From the signal 76, the processor VP generates an analog video signal 78 which is transmitted to the video processing device TDP. The device TDP generates from the signal 78 a digital video signal 79 which is transmitted to the display screen DS. The control touch panel DT transmits orders 81 resulting from pointing made by the user, to the logic control circuit CL. In return, the circuit CL elaborates control orders 84 which are transmitted to the video processor VP and control orders 82 which are transmitted to the processing device TDP.

In “remote control” mode, the control handle 1 is linked to a computer OP, for example of PC type, through an interface circuit INTC. The interface circuit INTO comprises a data compression video to USB coding circuit FG, and control format conversion circuit CVC. The coding circuit FG receives an analog video signal 80 transmitted by the video processor VP and supplies a compressed video signal USB which may be transmitted through a USB link 88 to the computer OP. The video signal 80 may be identical to the video signal 78. The conversion circuit CVC may connect through a USB link 86 to the computer OP. The circuit CVC receives from the computer OP logic orders in the USB format and converts these orders into a logic format such as the format RS 232, chosen for the logic commands managed by the control circuit CL. The circuit CVC may be bidirectional to convert data coming from the control circuit CL and to transmit them through the link 86 to the computer OP. The control circuit CL thus has a second input for receiving control signals 83 coming from the conversion circuit CVC. The umbilical cable 3 therefore comprises conductors allowing signals 80 and 83 to be transmitted, the proximal end of the umbilical cable 3 being connectable to the interface circuit INTC.

The computer OP conventionally comprises a visualization screen DS2 and several USB ports, a USB port 87 of which to connect to the control link 86, a USB port 89 of which to connect to the video link 88, and a USB port of which to connect to a USB key 90 allowing images coming from the videoendoscopic probe to be stored.

In “remote control” mode, the video signals 78, 79 transit between the video processor VP, the processing device TDP and the display screen DS.

The display screen performs its visualization function. The video links 80 and 88 are active. The touch panel DT and the logic link 81 are made inoperative, while the control links 82, 83, 84 and 86 are in service. In these conditions, the display screen DS only displays live native images supplied by the video processor VP.

The computer OP thus performs the following functions:
parametering and processing in real time the video signals processed by the video processor VP,
saving and processing in delay time the video images,
executing image processing programs in delay time, in particular those requiring a high computing power, and
viewing live images coming from the video processor and images coming from the processes in delay time.

FIGS. 6A to 6H show screen configurations displayed during various processing phases. FIGS. 6A, 6B show a screen configuration for respectively right handed and left handed user, displayed in the “live” operating mode. In FIGS. 6A, 6B, the screen is divided into an image display area 50, on the left in FIG. 6A and on the right in FIG. 6B, and a to control key display area 51 on the right in FIG. 6A and on the left in FIG. 6B. The image display area makes it possible to display images, in particular those coming from the image sensor, two lines of characters above the image, giving information on date/time and image identification, and an instruction line below the image.

The control key display area 51 has four navigation keys, upward 40, downward 41, leftward 42 and rightward 43. In the “live” operating mode where the image display area 50 displays images coming from the image sensor, these keys allows the angulation of the tip deflection to be controlled in the vertical plane, and in the horizontal plane.

The control key display area 51 also displays a key 44 controlling the return of the tip deflection in neutral position, a key 45 controlling image freezing, a key 46 controlling an image expansion and a key 47 controlling an increase of the image sensor sensitivity to compensate for insufficient lighting conditions. The key for returning in neutral position 44 may be displayed in green color when the tip deflection is in neutral position, and in red color when it has an angulation. The keys 46 and 47 may be displayed in red color when the corresponding functions are in service.

The control key display area 51 also displays two keys for changing the operating mode, i.e. a key 48 for accessing a library of images stored in a USB key plugged in the connector 18, and a key 49 for accessing a menu.

FIG. 6C shows a screen configuration displayed for a right handed user, when the key “MENU” 49 has been operated. The image display area 50 shows the various menu items. The control key display area 51 shows the four vertical and horizontal navigation keys 40 to 43, a key 52 allowing a selected item of the menu to be validated, and a key 53 for returning to the screen previously displayed. The vertical shift keys 40, 41 allows a menu item to be selected, and the horizontal shift keys 42, 43 allows an option associated to some menu items to be selected (for example yes/no for the titling or date/time items). It is to be noted that the screen technology implemented may also make it possible, if the user wishes it, to directly select a menu item or an item option (yes/no) by pointing a stylus on the item or the item option desired, then on the validation key 52.

FIG. 6D shows a screen configuration for a right handed user when a “frozen” image is displayed in the image area 50 (after operating the image to freezing control key 45). The image area 50 may also display the date and time at which the image displayed was frozen and a title. The control key display area 51 displays a key 54 controlling the storing of the frozen image into a library of images (for example in the JPEG standard in the USB key connected to the control handle 1), and the key 46 for controlling the image expansion. The control key display area 51 also displays three keys for changing the operating mode, i.e. the key 48 for accessing the library of images, the key 49 for accessing the menu and a key 55 for returning to the “live” mode for displaying images coming from the image sensor.

FIG. 6E shows a screen configuration for a right handed user, when the key 48 for accessing the library of images has been operated in a displayed screen. The image display area 50 displays a page showing the six last images stored on the USB key connected to the videoendoscopic probe. Each image is referenced by the Date/time information of its initial freezing. The control key display area 51 displays the four navigation keys 40 to 43 which are here used to select pages of images adjacent to the page displayed and to select an image in the page of images displayed. The image selected is indicated by a frame around the image references. The control key display area 51 also displays the key 52 here for controlling the display in full scale of the image selected, the key 53 for returning to the previous screen and a key 56 controlling the erase in the library of the images of the page of images displayed or the image selected. Here again, if the user desires it, the display in full scale of the image selected may be directly obtained by pointing a stylus on the image desired.

FIG. 6F shows a screen configuration for a right handed user, during the full-screen display of an image of the library, after activating the key 52 in the screen configuration of FIG. 6E. The image display area 50 shows the library image selected, and date/time information of its initial freezing. The control key display area 51 shows the navigation keys leftward 42 and rightward 43 to display images of the library adjacent to the image displayed. The control key display area 51 also shows the key 46 allowing the displayed image to be expanded, the key 54 allowing the image displayed to be saved, the key 56 allowing the image displayed to be erased in the library, and the key 53 for returning to the previous screen.

FIG. 6G shows a screen configuration for a right handed user, to during a first operating phase of a stereo measurement program selected in the screen configuration menu of FIG. 6C. The image display area 50 shows a splitted image 57, 58 either coming from the freezing of the endoscopic image coming from the image sensor associated to a distal “stereo” head, or a splitted image previously stored in the library. The two is lines of characters displayed above the splitted image 57, 58 show date/time information of the initial freezing of the image displayed, and allow the origin of the image to be identified. Below the image, a line of characters indicates the type of action to be performed in the context of the current operating phase.

The control key display area 51 shows the four navigation keys 40 to 43 for moving and positioning a cursor on a defect to be measured present on the splitted image 57, 58 displayed. The control key display area 51 also displays a key 60 for helping to the pointing to expand an image area around the cursor, the splitted image displayed on screen, the validation key 52 making it possible here to validate the pointing performed and to pass to a following operating phase of the stereo measurement program, and the key 53 for returning to the previous screen. It is to be noted that the screen technology implemented may also make it possible, if the operator desires it, to directly perform the pointing required by the stereo measurement program, by directly positioning the tip of a stylus on the end of the defect to be measured on the splitted image displayed on the screen.

FIG. 6H shows a screen configuration for a right handed user, allowing an image title to be input, after selecting the corresponding operation in the “menu” screen of FIG. 6C. The image display area 50 shows in background the endoscopic image coming from the image sensor or the “frozen” image concerned by titling. Above the image, a line of characters supplying date/time information of the displayed image, and another line in which the title made by the user will form are displayed. In surimpression by encrustation in the endoscopic image, the display area 50 shows a keyboard (AZERTY or QWERTY according to a choice previously made in the menu) comprising the current typing keys. The control key display area 51 has the four navigation keys 40 to 43 which makes it possible here to select a character or a control key displayed in the display area 50, the key 52 for validating the character selected, and the key 53 for to returning to the previous screen. Here again, if the user wishes it, the title may be introduced by directly selecting the successive characters of the title using a stylus or a finger.

It is to be noted that the control key display area 51 has a sufficient surface to display several control keys of sufficient size to be able to be individually operated by a finger of the user or using a stylus.

It will appear clearly to those skilled in the art that the present invention is susceptible of various embodiments and applications. In particular, the invention is not limited to the control handle shape shown in FIGS. 2 to 4. The important thing is simply that the control handle integrates a display screen associated to a touch panel, having a format such that images from the image sensor may be displayed by respecting their format by occupying substantially the whole height of the display screen (with a possible difference of two or three text lines), but leaving one or two lateral areas at the right and/or the left of the endoscopic image displayed, to display control keys of sufficient size to be able to be individually operated.

It is not necessary either that the videoendoscopic probe can connect to an external operating equipment. Indeed, the probe previously described may comprise only one autonomous control mode in which it is controlled by the touch panel only and displays images and control keys on the screen of the control handle.

1. A method for controlling a videoendoscope comprising a videoendoscopic probe comprising an inspection tube having a distal end housing an image sensor, and a control handle fixed to the proximal end of the inspection tube, the control handle comprising a display screen, and a video processing circuit connected to the image sensor and the display screen,
the method comprising:
providing the control handle with a display screen and a touch panel covering the display screen, the display screen and the touch panel having a to format such that their surface may be divided into an image display area occupying a whole height of the display screen and having a format corresponding to that of a photosensitive surface of the image sensor, and a lateral control key display area having a sufficient surface to display several control keys of sufficient size to be individually operated, and
controlling the display screen and the touch panel so as to display an image elaborated from signals coming from the image sensor in the image display area, and several control keys in the lateral control key display area.

2. The method according to claim 1, comprising controlling the display screen and the touch panel so as to display and manage in the control key display area all the control keys necessary to a usual operating phase of the videoendoscopic probe.

3. The method according to claim 1, comprising controlling the display screen and the touch panel so as to display the control key display area at the left and/or at the right of the image display area, according to a configuration parameter.

4. The method according to claim 1, comprising controlling the display screen so as to display a control key in the control display area in various ways according to the state of a function controlled by the control key.

5. The method according to claim 1, comprising controlling the display screen and the touch panel so as to display and manage navigation keys upward, downward, leftward and rightward, to control a distal tip deflection of the videoendoscopic probe.

6. The method according to claim 1, comprising configuring the videoendoscopic probe in an autonomous control mode in which the probe is controlled from the touch panel, or in a remote mode in which the probe is controlled from a computer to which it is connected.

7. The method according to claim 1, comprising controlling the videoendoscopic probe so as to perform at least one of the following functions:
managing information configured according to an operating phase currently processed and displayed in the image display area,
managing control keys displayed in the control key display area, according to the operating phase currently processed, and
managing orders introduced through the touch panel, by activating a control key displayed.

8. A videoendoscope comprising a videoendoscopic probe comprising an inspection tube having a distal end housing an image sensor, and a control handle fixed to the proximal end of the inspection tube, the control handle comprising a display screen, and a video processing circuit connected to the image sensor, the display screen and a proximal multicore cable allowing the video processing circuit to be connected to an operating equipment,
wherein the display screen is covered by a touch panel, the display screen and the touch panel having a format such that their surface may be divided into an image display area occupying a whole height of the display screen and having a format corresponding to that of a photosensitive surface of the image sensor, and a lateral control key display area having a sufficient surface to display several control keys of sufficient size to be individually operated, the videoendoscope being configured to control the display screen and the touch panel so as to display an image elaborated from signals coming from the image sensor in the image display area, and several control keys in the lateral control key display area.

9. The videoendoscope according to claim 8, configured to control the display screen and the touch panel so as to display and manage in the control key display area all the control keys necessary to a usual operating phase of the videoendoscopic probe.

10. The videoendoscope according to claim 8, configured to control the display screen and the touch panel so as to display the control key display area at the left and/or at the right of the image display area, according to a configuration parameter.

11. The videoendoscope according to claim 8, configured to control the display screen and the touch panel so as to display a control key in the control display area in various ways according to the state of a function controlled by the control key.

12. The videoendoscope according to claim 8, configured to control the display screen and the touch panel so as to display and manage navigation keys upward, downward, leftward and rightward, to control a distal tip deflection of the videoendoscopic probe.

13. The videoendoscope according to claim 8, configured to have an autonomous control mode in which it is controlled from the touch panel, or in a remote mode in which it is controlled from a computer to which it is connected.

14. The videoendoscope according to claim 8, configured to perform at least one of the following functions:
managing information configured according to an operating phase currently processed and displayed in the image display area,
managing control keys displayed in the control key display area, according to the operating phase currently processed, and
managing orders introduced through the touch panel, by activating a control key displayed.

15. The videoendoscope according to claim 8, wherein the display screen and the touch panel have a 16/9 format, while the photosensitive surface of the image sensor has a 4/3 format.

16. The videoendoscope according to claim 8, wherein the video processing circuit is connected to a proximal multicore cable allowing the video processing circuit to be connected to an external operating equipment.

17. A videoendoscopic system comprising a videoendoscope and a computer connected to the videoendoscope through an interface circuit, the videoendoscope comprising a videoendoscopic probe comprising an inspection tube having a distal end housing an image sensor, and a control handle fixed to the proximal end of the inspection tube, the control handle comprising a display screen, and a video processing circuit connected to the image sensor, the display screen and a proximal multicore cable allowing the video processing circuit to be connected to an operating equipment,
wherein the display screen is covered by a touch panel, the display screen and the touch panel having a format such that their surface may be divided into an image display area occupying a whole height of the display screen and having a format corresponding to that of a photosensitive surface of the image sensor, and a lateral control key display area having a sufficient surface to display several control keys of sufficient size to be individually operated, the videoendoscope being configured to control the display screen and the touch panel so as to display an image elaborated from signals coming from the image sensor in the image display area, and several control keys in the lateral control key display area.

18. The videoendoscopic system according to claim 17, wherein the videoendoscope is configured to control the display screen and the touch panel so as to display and manage in the control key display area all the control keys necessary for a usual operating phase of the videoendoscopic probe.

19. The videoendoscopic system according to claim 17, wherein the videoendoscope is configured to control the display screen and the touch panel so as to display the control key display area at the left and/or at the right of the image display area, according to a configuration parameter.

20. The videoendoscopic system according to claim 17, wherein the videoendoscope is configured to control the display screen and the touch panel so as to display a control key in the control display area in various ways according to the state of a function controlled by the control key.

21. The videoendoscopic system according to claim 17, wherein the videoendoscope is configured to control the display screen and the touch panel so as to display and manage navigation keys upward, downward, leftward and rightward, to control a distal tip deflection of the videoendoscopic probe.

22. The videoendoscopic system according to claim 17, wherein the videoendoscope is configured to have an autonomous control mode in which it is controlled from the touch panel, or a remote mode in which it is controlled from a computer to which it is connected.

23. The videoendoscopic system according to claim 17, wherein the videoendoscope is configured to perform at least one of the following functions:
managing information configured according to an operating phase currently processed and displayed in the image display area,
managing control keys displayed in the control key display area, according to the operating phase currently processed, and
managing orders introduced through the touch panel, by activating a control key displayed.

24. The videoendoscopic system according to claim 17, wherein the display screen and the touch panel have a 16/9 format, while the photosensitive surface of the image sensor has a 4/3 format.

25. The videoendoscopic system according to claim 17, wherein the video processing circuit is connected to a proximal multicore cable allowing the video processing circuit to be connected to an external operating equipment.

26. The videoendoscopic system according to claim 17, wherein the computer is configured to perform, in a remote control mode of the videoendoscope, at least one of the following functions:
parametering and process functions in real time of the video signals processed by the video processor VP,
saving and processing in delay time the video signals,
executing an image process program in delay time,
visualizing images coming from the videoendoscopic probe and coming from process in delay time.

27. The videoendoscopic system according to claim 17, wherein the interface circuit is configured to be connected to the computer through a link of USB type to transmit video images between the videoendoscope and the computer, and a link of USB type to transmit commands of the videoendoscope from the computer in a remote control mode of the videoendoscope.
